(19) United States
(12) Patent Application Publication
(10) Pub. No.: US 2004/0232757 A1
(43) Pub. Date: Nov. 25, 2004

(54) Wheel cover

(75) Inventor: Chiu Hsien-Yu, Taipei (TW)

Correspondence Address: DENNISON, SCHULTZ, DOUGHERTY & MACDONALD, 1727 KING STREET, SUITE 105, ALEXANDRIA, VA, 22314, US

(73) Assignee: MEXA CO. LTD.

(21) Appl. No.: 10/768,116

(22) Filed: Feb. 2, 2004

(30) Foreign Application Priority Data
May 21, 2003 (TW) 92209348

(51) Int. Cl. B60B 7/04

(52) U.S. Cl. 301/37.25

(57) ABSTRACT

A wheel cover comprising a lower cover fixed onto the brim of a tyre, a bearing stand is beneath and fixed on lower cover with screws, a bearing is inside the bearing stand; a movable upper cover is on top of and fixed on the lower cover with screws. When tires stop turning, the upper cover can still turn by the centrifugal force generated by the bearing in the bearing stand and the upper cover itself turning along with tire, viewers can feel the effect that the tire is still running.

### BACKGROUND OF THE INVENTION

I. Field of the Invention

This invention relates generally to a wheel cover of tire and, more specifically, to a wheel cover that can still turn by centrifugal force when the tire stops running.

II. Description of the Prior Art

Heretofore, it is known that a wheel of a tire consists of a main cover, an auxiliary cover, a first supporting part and a second supporting part combining into a group and balance to each other; the main cover is an enlarged outer diameter cover, several fasteners are on the inner diameter on the back of the main cover stretching out in equal distance, the fasteners pass through the corresponding fastening holes on the auxiliary cover; a first supporting part corresponding to every fastener is on the fastening area, several elastic indentations are on the first supporting part to prop up the back of the auxiliary cover, the main cover and auxiliary cover can be properly fastened; several wedges arranged in ring shape are on the back of the auxiliary cover, a fastening area is on the bottom of every wedge as the position for a wedge of the second supporting part to be fastened on the brim of tire; the top of the auxiliary cover can be decorated as the disc brake, however the auxiliary cover is fixed on the main cover, when the types stop running, the auxiliary covers stop as well without movement to be dull and boring.

### SUMMARY OF THE INVENTION

It is therefore a primary object of the invention to provide a wheel cover comprising a lower cover fixed onto the brim of a tire, a bearing stand is beneath and fixed on lower cover with screws, a bearing is inside the bearing stand; a movable upper cover is on top of and fixed on the lower cover with screws. When tires stop turning, the upper cover can still turn by the centrifugal force generated by the bearing in the bearing stand and the upper cover itself turning along with tire, viewers can feel the effect that the tire is still running.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view of the present invention;

FIG. 3 is a cross-sectional view of the present invention.

### DESCRIPTION OF THE PREFERRED EMBODIMENT

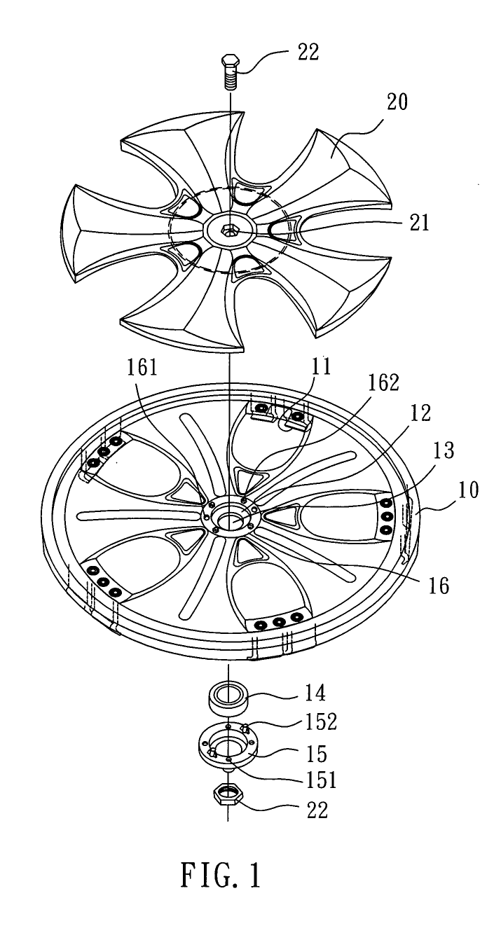

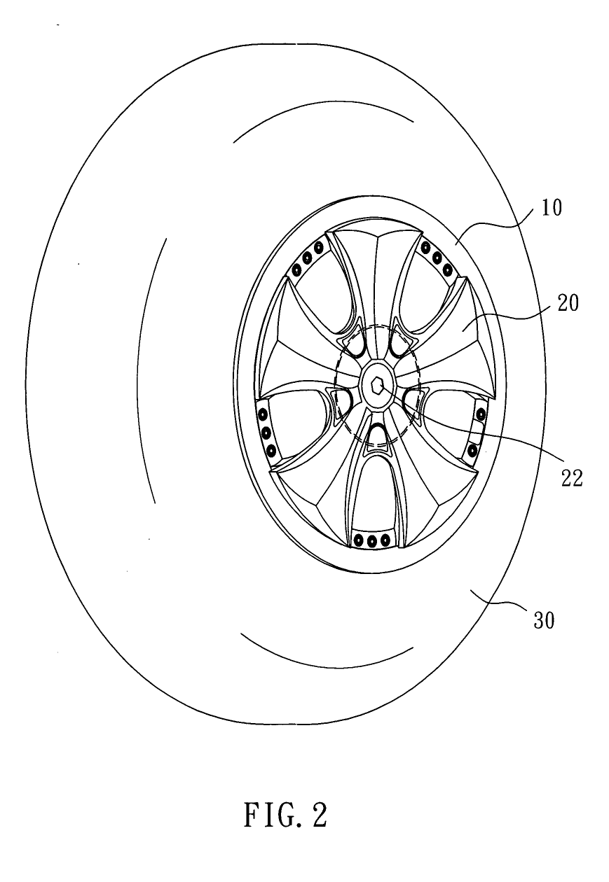

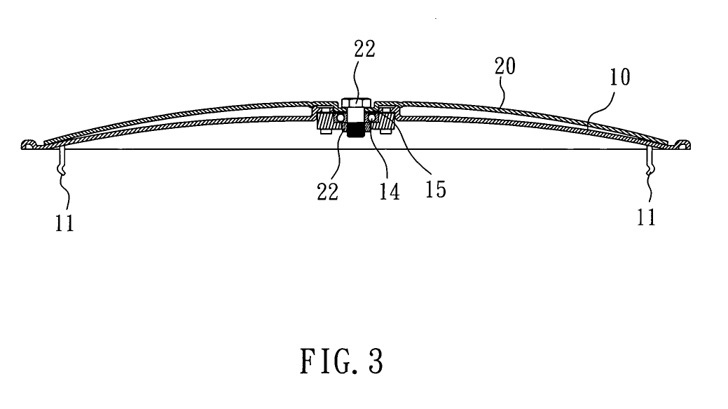

Referring to FIG. 1, the present invention is composed of a lower cover 10, the lower cover 10 can have many different models, several fastener 11 are on the circumference of the lower cover 10, these fastener 11 can be installed onto the brim (as shown in FIG. 3) of a tire 30 (as shown in FIG. 2), a concave ring 12 is on the center of the lower cover 10, a through hole 13 is on the center of the ring 12, a bearing 14 is under the lower cover 10, a bearing stand 15 is beneath the bearing 14; at least one lock hole 151 and one positioning pillar 152 is around the bearing stand 15, the positioning pillar 152 passes through a positioning hole 161 on the round ring 16 surrounding the ring 12 of the lower cover 10 for positioning; a through pillar 162 corresponding to the lock hole 151 is on the round ring 16 to have the bearing stand 15 stable beneath the lower cover 10 by the screw (not shown in FIG) passing through the lock hole 151.

A movable upper cover 20 is on top of the lower cover 10, the upper cover 20 can be in any model, a center hole 21 is on the center of the movable upper cover 20, the upper cover 20 is locked with the lower cover 10 and the bearing stand 15 by a locking device 22 (a screw and a nut in this application) passing through the through hole 13 of the ring 12, the bearing 14 and bearing stand 15.

Referring to FIG. 1 and FIG. 2, when tire 30 stops turning, the upper cover 20 can still turn by the centrifugal force generated by the bearing 14 in the bearing stand 15, viewers can feel the effect that the tire is still running.

Based on above description, the wheel of the present invention is very simple and easy to implement, users might have very high desire to apply; the present invention does improve the faulty structure of prior art and increase the practicability.

While a preferred embodiment of the invention has been shown and described in detail, it will be readily understood and appreciated that numerous omissions, changes and additions may be made without departing from the spirit and scope of the invention.

What is claimed is:

1. A wheel cover comprising:
a lower cover fixed onto the brim of a tire;
a bearing stand with a bearing on top is fixed beneath said lower cover;
a movable upper cover is on top of said lower cover, said upper cover is locked with said lower cover and said bearing stand by a locking device.

2. The wheel cover recited in claim 1, wherein at least positioning pillar 152 is around said bearing stand to pass through a positioning hole of said lower cover for positioning.

3. The wheel cover recited in claim 1, wherein at least one lock hole is around said bearing stand, a through pillar corresponding to every said lock hole on said lower cover, said bearing stand is stable beneath said lower cover by the screw passing through the lock hole and the through pillar that fixes said bearing.

4. The wheel cover recited in claim 1, wherein said locking device is the combination of a screw and a nut.
